(19) United States
(12) Patent Application Publication
(10) Pub. No.: US 2010/0081565 A1
(43) Pub. Date: Apr. 1, 2010

(54) Aluminum Phosphate Binder for Extruded Catalyst

(76) Inventors: Michael H. Quick, Arlington Heights, IL (US); Karl Z. Steigleder, Glen Ellyn, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/241,230

(22) Filed: Sep. 30, 2008

(51) Int. Cl. B01J 29/06

(52) U.S. Cl. 502/70; 502/64

(57) ABSTRACT

An extruded catalyst comprising at least one molecular sieve material and an amorphous aluminum phosphate binder wherein the aluminum phosphate binder remains substantially amorphous after calcining.

### BACKGROUND OF THE INVENTION

(1) Field of the Invention

This invention concerns extruded and calcined molecular sieve containing catalysts having substantially amorphous non-acidic aluminum phosphate binders as well as methods for making an using such extruded catalysts.

(2) Description of the Art

Catalyst and catalyst support formulations containing or similar molecular sieve materials such as zeolites are commonly formed by extrusion of a mixture of the catalytic material and a binder. Generally desirable properties for the binder material are good mixing/extrusion characteristics, good mechanical strength after calcination, and reasonable surface area and porosity to avoid possible diffusion problems during catalysts use.

Alumina (Al₂O₃) is a preferred binder for extruded molecular sieve catalysts for reasons of strength and also commercial availability of numerous suitable boehmite starting materials (Catapal, Versal, Pural, and the like) which extrude well and yield gamma-alumina upon calcination. However, for some extruded molecular sieve catalyst applications alumina cannot be used due to its inherent acidity which promotes undesirable side reactions such as excessive coke formation. Some examples of processes where alumina bound molecular sieve catalysts are not useful because of the inherent alumina acidity include, but are not limited to oligomerization or oligomerization-cracking of light olefins, and dehydro-cyclization of light paraffins.

Amorphous silica (SiO₂) has very low acidity and could be an alternative to alumina for such applications. However, silica binders tend to form weak extruded particles, and they also tend to show very poor extrusion characteristics due to an inherent lack of lubricity. There is a need, therefore, for new non-acidic binders for extruded molecular sieve catalysts for processes where acidic catalyst binders are avoided.

### SUMMARY OF THE INVENTION

The problems with acidic binders and weak binders have been overcome by identifying an aluminum phosphate binder that is useful in preparing strong extruded molecular sieve catalyst. The aluminum phosphate binders used in the catalysts of the present invention remains substantially amorphous even after calcine and, as a result, they have a lower molecular weight—in the range of 80 to 120 m²/g than aluminum phosphate materials manufactured by alternative methods. The lower surface area of the substantially amorphous aluminum phosphate binders used in the catalysts of this invention results in a decrease in the amount of contacting the noncatalytic binder portion of the catalyst in comparison to aluminum phosphate binders of the prior art.

One aspect of this invention an extruded calcined catalyst comprising at least one molecular sieve material; and an amorphous aluminum phosphate binder wherein the amorphous aluminum phosphate binder is prepared from an admixture of at least one water soluble aluminum salt and at least one phosphorous containing compound and wherein the aluminum phosphate binder remains substantially amorphous in the calcined catalyst.

Another aspect of this invention is a method for preparing an extruded catalyst comprising: admixing at least one water soluble aluminum salt and a phosphorous compound in the presence of a water to form a solution including aluminum phosphate particles; removing the water from the aluminum phosphate particles for form an aluminum phosphate powder; admixing the aluminum phosphate powder with a molecular sieve and at least one liquid to form a catalyst paste; directing the paste through a die associated with an extruder to form a catalyst extrudate; and calcining the catalyst extrudate to form a calcined extruded catalyst including at least one molecular sieve and a substantially amorphous aluminum phosphate binder.

Yet another aspect of this invention is a hydrocarbon conversion process comprising: a reactor including a feed inlet and a product outlet and further including a bed of extruded calcined catalyst, the calcined extruded catalyst including at least one molecular sieve material and an amorphous aluminum phosphate binder, the reactor capable of operating at light hydrocarbon conversion conditions; a light hydrocarbon feed that is directed into the reactor feed inlet; and a product that is formed when the light hydrocarbon feed reacts with the extruded catalyst at light hydrocarbon reaction conditions, wherein the product is removed from the reactor outlet.

### DETAILED DESCRIPTION OF THE INVENTION

The present invention relates to calcined extruded catalysts including at least one molecular sieve and a substantially amorphous non-acidic aluminum phosphate binder as well as methods for preparing the extruded catalysts and hydrocarbon conversion processes that use such catalysts.

The catalysts of this invention are calcined extruded catalysts comprising a combination of at least one molecular sieve and a substantially amorphous aluminum phosphate binder. The aluminum phosphate binder is prepared generally by admixing at least one aluminum salt with a phosphorous compound to form an aqueous solution including aluminum phosphate particles. The aluminum phosphate particles are separated from the aqueous solution and dried in at least one drying step and optionally in two drying steps to form a powdered aluminum phosphate catalyst binder material. The powdered aluminum phosphate catalyst binder is then combined with at least one molecular sieve and a liquid to form a paste and the paste is fed into an extruder to form a wet extrudate. The wet extrudate is then calcined to form a final catalyst product. The aluminum phosphate binder remains substantially amorphous even after the catalyst is calcined. Moreover the substantially amorphous aluminum phosphate binder in the calcined catalyst has an average surface area that is less than about 120 m²/g and preferably about 100 m²/g or less, both of which are lower that the about 150 m²/g surface area of the at least partially crystallized aluminum phosphate catalyst supports made by other methods such by oil drop methods.

As noted above, the aluminum phosphate binder remains substantially amorphous throughout the catalyst production including following calcining. The term “substantially amorphous” as used herein means that no more than a trace amount of crystallinity is detected in the calcined aluminum phosphate binder by x-ray crystallography techniques.

The extruded catalysts of this invention include at least one molecular sieve catalyst. Any molecular sieve material that is known to be catalytic in a hydrocarbon conversion process may be used in the extruded catalysts of this invention. “Molecular sieve” materials for purposes of this invention include, but are not limited to aluminosilicate minerals, clays, porous glasses, microporous charcoals, zeolites, active carbons, or synthetic compounds that have open structures through which small molecules can diffuse. Some examples of useful molecular sieve materials include, but are not limited to, MFI, MEL, EUO, FER, MFS, MTT, MTW, TON, MOR and FAU types of zeolites. Pentasil zeolites such as MFI, MEL, MTW and TON, and MFI-type zeolites, such as ZSM-5, silicalite, Borolite C, TS-1, TSZ, ZSM-12, SSZ-25, PSH-3, and ITQ-1. Preferred molecular sieves are selected from the group consisting of MFI, MOR, MTW, EUO, silicalite, MTT, MEL and mixtures thereof.

The at least one molecular sieve catalyst is combined with the substantially amorphous aluminum phosphate binder to form a paste that is extruded to form an extruded catalyst. The relative weight ratio of molecular sieve to binder in the catalyst may range from about 1:10 to about 10:1. It is preferred, however, that the catalyst includes from about 60 wt % to about 90 wt % of the molecular sieve material on a dry calcined basis.

The aluminum phosphate binder comprises a substantially amorphous aluminum phosphate powder. The atomic ratio of aluminum to phosphorus in the aluminum phosphate binder/matrix generally ranges from about 1:10 to 100:1, and more typically from about 1:5 to 20:1. The aluminum phosphate binder is prepared in a multiple step procedure. The first step is combining at least one aluminum salt with a phosphorous containing compound in water to form an aqueous solution including aluminum phosphate. The phosphorous containing compound may be any compound that is capable of reacting with the chosen aluminum salt in an aqueous solution to form aluminum phosphate particles. Preferred phosphorus compounds are phosphoric acid, phosphorous acid and ammonium phosphate. A most preferred phosphorous containing compound is phosphoric acid.

One or more aluminum salts are combined with the phosphoric containing compound in an aqueous solution to form aluminum phosphate binder particles. The aluminum salt may be selected from any aluminum salt that is combinable with a phosphorous compound in an aqueous solution to form aluminum phosphate particles. Non-limiting examples of useful aluminum salts include, but are not limited to aluminum nitrate, chloride salts of aluminum such as aluminum chloride, aluminum hydroxide, aluminum isoperoxide and combinations of aluminum salts. A preferred aluminum salt is an aqueous aluminum chlorohydrate solution. Aluminum chlorohydrate is a preferred aluminum salt composition because it has a high aluminum content by weight and thereby maximizes the weight of the aluminum in the combined aluminum salt/phosphorous compound aqueous composition. The preferred aluminum chlorohydrate composition has a general formula Al(OH)_{X}Cl_{3-X}. It is preferred that the aluminum chlorohydrate composition has a aluminum Al/Cl weight ratio of between 0.75 to 1.75. More preferably, the Al/Cl ratio will range between 0.80 to 1.25.

One or more aluminum salts are combined with the phosphorous compound in an aqueous solution such that the amount of ratio to aluminum to phosphorous (Al/P) in the solution is from about 1.0 to about 1.3. Moreover, the Al concentration in the solution will range from about 3-5% by weight. The precursor solution becomes unstable when the amount of aluminum in the solution increases beyond 5% by weight. The resulting admixed solution includes amorphous aluminum phosphate particles. The aqueous solution is removed from the amorphous aluminum phosphate particles by any methods known in the art and, in particular by drying. The drying may be accomplished by any methods known for drying a particulate containing solution such as by spray drying, flash drying or any other suitable drying methods. This first drying step will typically take place at a temperature of from 100 to 300° C. and the desired product is a free-flowing powder of solid amorphous aluminum phosphate.

The free-flowing powder of solid amorphous aluminum phosphate that is produced from the first drying step may be subjected to an optional second drying step. In the second drying step, the powder is dried at a temperature ranging from 250 to 400° C. for about 1-4 hours. The second drying step may be useful to alter the amorphous aluminum phosphate powder characteristics and to make the powder more amenable for use as a catalyst binder.

Optional gelling agents may be added to the aqueous aluminum salt/phosphorous compound solution during the preparation of the aluminum phosphate particles to form partially or fully gelled aluminum phosphate particles. Any gelling agent known in the art as being useful for forming an aluminum phosphate hydrogel may be used. Preferred gelling agents are chosen from compounds that release ammonia at elevated temperatures such as hexamethylene tetraamine (HMT), urea or mixtures thereof. A most preferred gelling agent is HMT.

The dried amorphous aluminum phosphate particles are next mixed with at least one molecular sieve in preparation for preparing an extruded catalyst. On a dry basis, the at least one molecular sieve is combined with the amorphous powdered aluminum phosphate binder in a weight ratio ranging from about 1:10 to 10:1. More preferably, the at least one molecular sieve will be combined with the amorphous powdered aluminum phosphate binder such that the resulting powder admixture includes from about 60 to 90 wt % and more preferably about 80 wt % of the at least one molecular sieve on a dry basis.

The catalysts of this invention are extrudates formed by well-known catalyst extrusion methods that initially involves combining the at least one molecular sieve and aluminum phosphate binder with water or some other liquid and an optional peptizing agent to form a homogeneous dough or thick paste having the correct moisture content to allow for the formation of extrudates with acceptable integrity to withstand direct calcination. The dry catalyst materials, i.e., the molecular sieve and binder may be admixed to form a heterogeneous powder mixture before adding liquid materials or the dry materials may be added individually to the wet ingredients. Extrudability is determined from an analysis of the moisture content of the dough, with moisture content in the range of from about 30 to about 50 mass % being preferred. The dough is then extruded through a die pierced with multiple holes and the spaghetti-shaped extrudate is cut to form particles in accordance with techniques well known in the art. A multitude of different extrudate shapes is possible, including, but not limited to, cylinders, cloverleaf, dumbbell, symmetrical and asymmetrical polylobates and so forth. It is also within the scope of this invention that the extrudates may be further shaped to any desired form, such as spheres, by marumerization or any other means known in the art.

Extruding agents or promoters may be added to the powdered admixture or to the paste prior to extrusion. Any extruding agent or promoter that is useful in preparing extruded catalyst and in particular extruded molecular sieve containing catalyst can be used during the extrusion process of the present invention. One type of useful and optional extrusion aid are elasticizers such as starch, cellulose, methylcellulose, glycerol and so forth.

The resulting extruded particles are then subjected to a calcination at a temperature of about 450° C. to 700° C. for a period of time ranging from about 1 to 20 hours. Following extrudate calcination, the aluminum phosphate binder surprisingly remains substantially amorphous and, as a result, exhibits a lower surface area in comparison to calcined aluminum phosphate materials that are at least partially crystalline. This results in improved contact between the hydrocarbon reactants and molecular sieve catalysts of this invention because there is less nonreactive binder surface area available for the hydrocarbon reactive content in the present catalyst.

The extruded catalysts of this invention may contain other components provided that they do not unduly adversely affect the performance of the finished catalyst. These components are preferably present in a minor amount, e.g., from 0 to less than about 40 mass %, and most preferably from 0 to less than about 15, mass % based upon the mass of the catalyst. These components include those that have found application in hydrocarbon conversion catalysts such as: (1) refractory inorganic oxides such as alumina, titania, zirconia, chromia, zinc oxide, magnesia, thoria, boria, silica-alumina, silica-magnesia, chromia-alumina, alumina-boria, silica-zirconia, phosphorus-alumina, etc.; (2) ceramics, porcelain, bauxite; (3) silica or silica gel, silicon carbide, clays and silicates including those synthetically prepared and naturally occurring, which may or may not be acid treated, for example, attapulgite clay, diatomaceous earth, fuller's earth, kaolin, kieselguhr, etc.; and (4) combinations of materials from one or more of these groups. Often, no additional binder component need be employed.

The catalyst of the present invention may contain a halogen component. The halogen component may be fluorine, chlorine, bromine or iodine or mixtures thereof, with chlorine being preferred. The halogen component is generally present in a combined state with the inorganic-oxide support. The optional halogen component is preferably well dispersed throughout the catalyst and may comprise from more than 0.2 to about 15 mass %, calculated on an elemental basis, of the final catalyst. The halogen component may be incorporated in the catalyst composite in any suitable manner, either during the preparation of the inorganic-oxide support or before, while or after other catalytic components are incorporated. Preferably, however, the catalyst contains no added halogen other than that associated with other catalyst components.

If desired, the catalyst may contain, a hydrogenation catalyst component such as a platinum-group metal, including one or more of platinum, palladium, rhodium, ruthenium osmium, and iridium. If used, a platinum group metal may be present in the catalysts in an amount of from about 20 to 3000 mass-ppm. Where the catalyst contains a platinum group metal, the resultant calcined composites often are subjected to a substantially water-free reduction step to ensure a uniform and finely divided dispersion of the optional metallic components. The reducing agent contacts the catalyst at conditions, including a temperature of from about 200° C. to about 650° C. and for a period of from about 0.5 to about 10 hours, effective to reduce substantially all of the platinum group metal component to the metallic state.

It is within the scope of the present invention that the catalyst may contain other metal components known to modify the effect of the hydrogenation metal component. Such metal modifiers may include without so limiting the invention rhenium, tin, germanium, lead, cobalt, nickel, indium, gallium, zinc, and mixtures thereof. Catalytically effective amounts of such metal modifiers may be incorporated into the catalyst by any means known in the art to effect a homogeneous or stratified distribution.

Catalytically effective amounts of such modifiers may be incorporated into the catalysts by any means known in the art to effect a homogeneous or stratified distribution such as by liquid impregnation or by incorporating the modifiers into the extrusion dough.

The extruded catalysts of this invention are useful in hydrocarbon conversion processes that preferably employ nonacidic catalyst. Examples of such hydrocarbon conversion processes include, but are not limited to xylene isomerization, olefin cracking, ethylbenzene dealkylation and trans-alkylation of alkyl aromatics. In such processes, the calcined catalyst of this invention is placed in a reactor having at least one inlet and at least one outlet. The reactors is operated at appropriate reaction conditions of temperature and pressure and an appropriate hydrocarbon feed is directed into the reactor inlet. The hydrocarbon feed reacts with the catalyst at the chosen reaction conditions to produce a product that is removed from the reactor at the reactor outlet.

### EXAMPLE

This example describes the preparation of certain extruded calcined catalysts of this invention comprising at least one molecular sieve and a substantially amorphous aluminum phosphate binder.

The initial step in forming an aluminum phosphate binder of the present invention is the preparation of an aluminum phosphate solution from an aluminum compound and phosphorous compound—in this case, phosphoric acid (H₃PO₄). Any water-soluble aluminum salt may be suitable, but the preferred aluminum salt is an aqueous aluminum chlorohydrate solution. Aluminum chlorohydrate (ACH) is a partially hydrolyzed form of aluminum chloride (AlCl₃) and has the general formula of Al(OH)ₓCl₃₋ₓ. It is commercially available with various compositions, or can readily be made to the desired composition by reaction of aluminum metal with hydrochloric acid or aqueous aluminum chloride. The advantage of ACH for manufacturing purposes is that it yields a solution of higher Al content than any other source, up to about 15% by weight of Al.

To prepare the aluminum phosphate solution, phosphoric acid (preferably 85 weight %) is added gradually, with rapid stirring, to a solution of ACH and water. The amounts of ACH, H₃PO₄ and water are selected such that the molar ratio of aluminum to phosphorus (Al/P) will be 1.0 and the final Al concentration in the solution will be about 3-5% by weight. The process is exothermic, and the ACH solution must be maintained at about 15° C. or lower during addition of the phosphoric acid to avoid gelation or precipitation of the aluminum phosphate as it is formed. The resulting aqueous aluminum phosphate solution contains amorphous aluminum phosphate at a concentration of about 13.5 to 22.5 weight %, and is stable at room temperature for several days.

The next step is preparation of a powder from the solution by spray-drying, flash-drying, or other suitable methods to produce a free-flowing powder of solid amorphous aluminum phosphate. The drying will typically take place quickly at a temperature of from 100° C. to 300° C. and in the case of spray drying, at about 200° C.

In an alternative processing step, prior to the drying step, a quantity of a gelling agent such as hexamethylene tetramine (HMT) may be added to the aluminum phosphate solution. HMT thermally decomposes during the drying step to liberate ammonia (NH₃) and induce some degree of gelation in the aluminum phosphate particles as they dry, which can alter the textural properties (porosity and surface area) of the final dried aluminum phosphate powder. The HMT is added to the aluminum phosphate solution as an aqueous solution of about 40% HMT by weight. The amount of HMT used should preferably be such that the molar ratio of NH₃ from the HMT to chloride from the initial aluminum phosphate solution ranges from about 0.5 to 1.0.

The amorphous aluminum phosphate powder produced above has a high solubility, and may tend to form a sticky, intractable mass upon re-wetting. Therefore, the initial dried powder can be subjected to an optional second drying step at somewhat higher temperatures that the first drying step in order to lower the powder surface area and solubility to make it more amenable to use as an extruded catalyst binder. The second drying step will generally take place at temperatures ranging from about 250-400° C. and for about 1-4 hours. The higher-temperature treatment has the added benefit of removing most of the remaining chloride impurity from the starting ACH compound, and also any residual HMT, if used, from the dried powder.

The final dried power is an amorphous aluminum phosphate that is stable indefinitely, is suitable as a non-acidic binder for catalyst formulations, and can be used for manufacturing catalysts by extrusion in much the same way as a typical boehmite alumina binder is used.

Typically, the molecular sieve or other catalytic powder is mixed with the amorphous aluminum phosphate binder powder in a proportion by weight of about 1:10 to 10:1. Water is added to the powder mixture and ff necessary, a small amount of an acid (e.g., nitric, hydrochloric, acetic, formic, etc.) in an amount ranging from 1 to 10 wt % is added for peptization purposes. The admixture is formed into a dough-like paste using a suitable mixer (muller, kneader, rotating chopper, etc.). The “dough” is then fed to an extruder (auger or piston type) and forced through a perforated die plate with holes of the desired size and shape. The resulting extrudates are dried at about 100-200° C., and then calcined at about 500-650° C. to drive off residual water to set the binder and activate the catalytic material. The final calcined extrudates bound with the aluminum phosphate binder described herein should have good strength. The binder portion of the composite should have a reasonable surface area and porosity, but little or no acidity that would interfere with the reaction selectivity of the catalytic component.

1. An extruded calcined catalyst comprising:
at least one molecular sieve material; and
an amorphous aluminum phosphate binder wherein the amorphous aluminum phosphate binder is prepared from an admixture of at least one water soluble aluminum salt and at least one phosphorous containing compound and wherein the aluminum phosphate binder remains substantially amorphous in the calcined catalyst.

2. The catalyst of claim 1 wherein the water soluble aluminum salt includes from about 10% to about 15% by weight of aluminum.

3. The catalyst of claim 1 wherein the water soluble aluminum salt includes about 15% by weight aluminum salt.

4. The catalyst of claim 1 wherein the water soluble aluminum salt is an aluminum chlorohydrate.

5. The catalyst of claim 4 wherein the aluminum chlorohydrate has an Al/Cl weight ratio of from 0.8 to 1.25.

6. The catalyst of claim 1 wherein a gelation promoter is added to the admixture.

7. The catalyst of claim 6 wherein the gelation promoter is hexamethylene tetraamine.

8. The catalyst of claim 1 wherein the weight ratio of the at least one molecular sieve material and the amorphous aluminum phosphate binder ranges from about 10:1 to 1:10.

9. The catalyst of claim 1 wherein the substantially amorphous aluminum phosphate binder has a surface area no greater than about 120 m²/g.

10. The catalyst of claim 1 wherein the at least one molecular sieve is selected from the group consisting of MFI, MOR, MTW, EUO, silicalite, MTT, MEL and mixtures thereof.

11. A method for preparing an extruded catalyst comprising:
a. admixing at least one water soluble aluminum salt and a phosphorous compound in the presence of a water to form a solution including aluminum phosphate particles.
b. removing the water from the aluminum phosphate particles for form an aluminum phosphate powder;
c. admixing the aluminum phosphate powder with a molecular sieve and at least one liquid to form a catalyst paste;
d. directing the paste through a die associated with an extruder to form a catalyst extrudate; and
e. calcining the catalyst extrudate to form a calcined extruded catalyst including at least one molecular sieve and a substantially amorphous aluminum phosphate binder.

12. The method of claim 11 wherein the water is removed from the aluminum phosphate particles in step (b) by a first drying step selected from the group consisting of spray drying or flash drying to form dried aluminum phosphate particles.

13. The method of claim 12 wherein the dried aluminum phosphate particles are further dried in a second drying step.

14. The method of claim 11 wherein the phosphorous containing compound is phosphoric acid and the aluminum salt is aluminum chlorohydrate has an Al/Cl weight ratio of from 0.8 to 1.25.

15. The method of claim 11 wherein the aluminum phosphate binder in the extruded catalyst product has a surface area of no more than 120 m²/g.

16. A hydrocarbon conversion process comprising:
a reactor including a feed inlet and a product outlet and further including a bed of extruded calcined catalyst, the extruded calcined catalyst including at least one molecular sieve material and an amorphous aluminum phosphate binder, the reactor capable of operating at light hydrocarbon conversion conditions;
a light hydrocarbon feed that is directed into the reactor feed inlet; and
a product that is formed when the light hydrocarbon feed reacts with the extruded catalyst at light hydrocarbon reaction conditions, wherein the product is removed from the reactor outlet.

17. The hydrocarbon conversion process of claim 16 wherein the amorphous aluminum phosphate binder is prepared from an admixture of at least one water soluble aluminum salt and at least one phosphorous containing compound.

18. The hydrocarbon conversion process of claim 16 wherein the process is selected from the group consisting of xylene isomerization, olefin cracking, ethylbenzene dealkylation and trans-alkylation of alkyl aromatics.

19. The hydrocarbon conversion process of claim 16 wherein the aluminum phosphate binder in the extruded and calcined catalyst product has a surface area of no more than 120 m²/g.

20. The hydrocarbon conversion process of claim 16 wherein the aluminum phosphate binder in the extruded and calcined catalyst product has a surface area of about 100 m²/g or less.
